(19) United States
(12) Patent Application Publication
(10) Pub. No.: US 2008/0187112 A1
(43) Pub. Date: Aug. 7, 2008

(54) METHOD AND SYSTEM FOR DELIVERING PODCASTS TO COMMUNICATION DEVICES

(75) Inventors: Dave Koberstein, Mountain View, CA (US); Kevin J. Duffy, Los Gatos, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Tribal Shout!, Inc., Mountain View, CA (US)

(21) Appl. No.: 11/831,898

(22) Filed: Jul. 31, 2007

Related U.S. Application Data
(60) Provisional application No. 60/888,657, filed on Feb. 7, 2007.

(51) Int. Cl. H04M 1/64; H04M 11/00

(52) U.S. Cl. 379/88.17; 379/93.01

(57) ABSTRACT

A method for communicating audio content from one or more web sites to one or more communication devices, e.g., cellular phone, VoIP phone. The method includes maintaining an account for a user. In a specific embodiment, the account includes a first telephone number, which is uniquely associated with the user. In a specific embodiment, the account is directed to a customized account on a web site associated with an audio service for the user. In a specific embodiment, the web site is coupled to the Internet and/or other like world wide area network. The method includes maintaining one or more media files on one or more mass storage devices coupled to the customized account on the web site for the user. Each of the one or more media files is capable of distribution by subscription (paid or unpaid) over the Internet using one or more syndication feeds. The method includes maintaining a database schema characterized by one or more preferences for the user of the customized account. In a specific embodiment, the database schema is coupled to the customized account for the audio service. The method includes inputting a second telephone number into a communication device. The second telephone number is associated with the audio service of the web site.

### CROSS-REFERENCES TO RELATED APPLICATIONS

This application claims priority to U.S. Ser. No. 60/888,657 filed Feb. 7, 2007, commonly assigned, and hereby incorporated by reference herein.

Additionally, this application is related to co-pending U.S. patent application Ser. No. ______, filed same date of this application (Attorney Docket No. 026746-000110US) commonly assigned, incorporated by reference herein for all purposes.

### STATEMENT AS TO RIGHTS TO INVENTIONS MADE UNDER FEDERALLY SPONSORED RESEARCH AND DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

### COPYRIGHT NOTICE

A portion of the disclosure of this patent document contains material that is subject to copyright protection. The copyright owner has no objection to anyone reproducing the patent disclosure as it appears in the Patent and Trademark Office patent files or records; however, the copyright owner strictly reserves all other rights of usage.

### BACKGROUND OF THE INVENTION

The present invention is related to the field of voice communications. More particularly, the present invention provides a method and system for selectively outputting one or more podcasts using communications devices. As an example, the present invention is provided in the context of delayed broadcasting and messaging. It relates specifically to the distribution to telephone handsets, and other devices capable of receiving telephone calls, of computer files known as podcasts that are available on the Internet and that typically are downloaded and processed either by general purpose computers or by special purpose devices other than telephones. The present invention further relates to methods for using database systems to download, transcode, manage, store, and redistribute podcast files, as well as other applications.

Wikipedia defines podcasting as “ . . . the method of distributing multimedia files, such as audio or video programs, over the Internet using syndication feeds, for playback on mobile devices and personal computers.” The term “podcast” is used to refer to multimedia files that are so distributed and that, except for the method of distribution, are otherwise not different from multimedia files of the same type that are not distributed via podcasting. In the present state of the art, “mobile devices,” as used in Wikepedia's definition, does not include standard telephone handsets. The present invention, therefore, makes podcasts available to a much larger user base.

Podcasts are becoming increasingly common and important for distribution of both commercial and private dispatches. Podcasting differs from broadcasting in that podcasts can be retrieved at a user's convenience instead of on a certain day and at a particular time. The current invention differs from recording broadcasts in that the user needs only to identify podcasts of interest and does not need to manage recording devices and worry about the correct day, time, and channel.

In the field of podcasting, “podcast” can refer either to a multimedia file or to the name of the source at which the file can be found (similar to the name of a radio or television program), “feed” refers to the internet address (URL) at which a podcast can be found and downloaded (corresponding to the channel at which a radio or television program can be found), and “episode” has the same meaning as when used in reference to radio or television programming. Podcasting episodes are contained in separate podcast “files” that can be stored like other computer files. Therefore, unlike in broadcasting or most other messaging systems, past episodes of podcasts are generally available for users who missed them when they first were released or who wish to play them again.

Unfortunately, podcasting has limitations. As an example, a shortcoming of podcasting is that users cannot dial up and listen to podcasts from their telephones or from such other devices that are capable of receiving and processing telephone traffic. Such shortcoming often limits travelers and other mobile users' access to podcasts. Accordingly, podcasts have had limited distribution. Other limitations can also exist.

From the above, it is seen that improved ways of distributing information over communication networks is highly desired.

### BRIEF SUMMARY OF THE INVENTION

According to the present invention, techniques for voice communications are provided. More particularly, the present invention provides a method and system for selectively outputting one or more podcasts using communications devices. As an example, the present invention is provided in the context of delayed broadcasting and messaging. It relates specifically to the distribution to telephone handsets, and other devices capable of receiving telephone calls, of computer files known as podcasts that are available on the Internet and that typically are downloaded and processed either by general purpose computers or by special purpose devices other than telephones. The present invention further relates to methods for using database systems to download, transcode, manage, store, and redistribute podcast files, as well as other applications.

In a specific embodiment, the present invention provides a method for communicating audio content from one or more web sites to one or more communication devices, e.g., cellular phone, VoIP phone, land line, smart phone, desktop, laptop. The method includes maintaining an account for a user. In a specific embodiment, the account includes a first telephone number, which is uniquely associated with the user. In a specific embodiment, the account is directed to a customized account on a web site associated with an audio service for the user. In a specific embodiment, the web site is coupled to the Internet and/or other like world wide area network. The method includes maintaining one or more media files on one or more mass storage devices coupled to the customized account on the web site for the user. Each of the one or more media files is capable of distribution by subscription (paid or unpaid) over the Internet using one or more syndication feeds. The method includes maintaining a database schema characterized by one or more preferences for the user of the customized account. In a specific embodiment, the database schema is coupled to the customized account for the audio service. The method includes inputting a second telephone number into a communication device. The second telephone number is associated with the audio service of the web site.

In a specific embodiment, the method includes transferring information associated with the second telephone number through a circuit switched telephone network from the communication device. The second telephone number is associated with the audio process. In a specific embodiment, the method forms a connection between the communication device and the audio service through the circuit switched telephone network. In a specific embodiment, the method also includes selecting one or more of the media files using the communication device. The method also processes the one or more media files to convert the one or more media files from a first format to a second format. In a specific embodiment, the method transmits the one or more media files in the second format through the telephone network and outputs audio information associated with the one or more media files to the user using the communication device.

In an alternative specific embodiment, the present invention provides an alternative method for communicating audio content from one or more web sites to one or more communication devices. The method includes maintaining an account for a user. In a specific embodiment, the account includes a first telephone number, which is uniquely associated with the user. In a specific embodiment, the account is directed to a customized account on a web site associated with an audio service for the user. In a specific embodiment, the web site is coupled to the Internet and/or other like world wide area network. The method includes maintaining one or more media files on one or more mass storage devices coupled to the customized account on the web site for the user. Each of the one or more media files is capable of distribution by subscription (paid or unpaid) over the Internet using one or more syndication feeds. The method includes maintaining a database schema characterized by one or more preferences for the user of the customized account. In a specific embodiment, the database schema is coupled to the customized account for the audio service.

In a specific embodiment, the method also includes inputting a second telephone number into a communication device from the user of the first telephone number or a non-registered user of a non-registered telephone number. The second telephone number is associated with the audio service of the web site. The method includes transferring information associated with the second telephone number through a circuit switched telephone network from the communication device. The method includes forming a connection between the communication device of the user of the first telephone number or of the non-registered user of the non-registered telephone number and the audio service through the circuit switched telephone network. In a specific embodiment, the method also includes selecting one or more of the media files from the customized account using the communication device of the user or selecting one or more default media files for the non-registered user. The method includes processing the one or more media files to convert the one or more media files from a first format to a second format and transmitting the one or more media files in the second format through the telephone network. In a specific embodiment, the method includes outputting audio information associated with the one or more media files to the user using the communication device.

Still further, the present invention provides a system for communicating audio content from one or more web sites to one or more communication devices. The system includes an account for a user, which has a first telephone number, which is uniquely associated with the user. In a preferred embodiment, the account is directed to a customized account on a web site associated with an audio service for the user. In a specific embodiment, the system has one or more media files on one or more mass storage devices coupled to the customized account on the web site for the user. Each of the one or more media files is capable of distribution by subscription (paid or unpaid) over the Internet using one or more syndication feeds. A database schema is characterized by one or more preferences for the user of the customized account according to a specific embodiment. The database schema is coupled to the customized account for the audio service.

In a preferred embodiment, the system has one or more computer readable memories including computer code(s). Such computer codes can be configured to carry out the various methods described herein, as well as outside of the present specification. In a specific embodiment, one or more codes is directed to receiving information associated with a second telephone number from a communication device. The second telephone number is associated with the audio service of the web site according to a specific embodiment. The information is associated with the second telephone number through a circuit switched telephone network from the communication device according to a specific embodiment. The second telephone number is associated with the audio process according to a specific embodiment. There are also one or more codes directed to forming a connection between the communication device and the audio service through the circuit switched telephone network and one or more codes is directed to selecting one or more of the media files using the communication device. One or more codes is directed to processing the one or more media files to convert the one or more media files from a first format to a second format. One or more codes is directed to transmitting the one or more media files in the second format through the telephone network.

In still a further alternative embodiment, the present invention provides a method for communicating audio content from one or more web sites to one or more communication devices. The method includes inputting a telephone number into a communication device, the telephone number being associated with an audio session. The method also includes transferring information associated with the telephone number through a circuit switched telephone network from the communication device, the telephone number being associated with the audio session according to a specific embodiment. The method includes forming a connection between the communication device and the audio session through the circuit switched telephone network and selecting one or more of the media files using the communication device associated with the audio session. In a specific embodiment, the method includes processing the one or more media files to convert the one or more media files from a first format to a second format and transmitting the one or more media files in the second format through the telephone network. The method includes outputting audio information associated with the one or more media files to the user using the communication device and terminating the audio session voluntarily or involuntarily. In a specific embodiment, the method includes determining a pause point associated with a time associated with a time when the audio session was terminated.

In yet an alternative embodiment, the present invention provides a database system comprising media files to be transmitted to one or more communication devices. The database system has a web interface coupled to the Internet and one or more mass storage devices coupled to the web interface. The system also has one or more media files provided on the one or more mass storage devices coupled to the web interface. Each of the one or more media files is capable of distribution by subscription (paid or unpaid) over the Internet using one or more syndication feeds. Each of the one or more media files is pre-processed to be transmitted over a circuit switched and/or packet switched network coupled to the Internet. A plurality of database schema numbered from 1 through N, where N is an integer greater than 10, are included. Each of the numbers is associated with a unique user from a plurality of users. The plurality of users are numbered respectively from 1 through N. Each of the data schema is characterized by one or more preferences for the unique user.

In a specific embodiment, the present invention provides a method for populating a database. The method includes providing one or more mass storage devices, e.g., hard disk drives. The method includes providing one or more media files. The method includes processing the one or more media files, each of the one or more media files being capable of distribution by subscription (paid or unpaid) over the Internet using one or more syndication feeds, such that each of the one or more media files being capable of being transmitted over a circuit switched and/or packet switched network coupled to the Internet. The method includes storing the one or more media files onto one or more portions of the one or more mass storage devices.

Certain advantages and/or benefits may be achieved using the present invention. For example, the present technique provides a method and system for an easy to use process that relies upon conventional computer hardware and software technologies. In some embodiments, the method and system can be fully automated. In a preferred embodiment, the present invention provides a method and system for an efficient way of distributing podcasts using conventional telecommunication devices including cellular phone without any modification and the like. Additionally, the present method and system can also be used to convert any podcast for efficient storage and playback according to a specific embodiment of the present invention. Depending upon the embodiment, one or more of these benefits may be achieved. These and other benefits will be described in more throughout the present specification and more particularly below.

Other features and advantages of the invention will become apparent through the following detailed description, the drawings, and the claims.

### BRIEF DESCRIPTION OF THE DRAWINGS

FIG. 1 is a simplified diagram of a system for delivering podcasts according to an embodiment of the present invention;

FIGS. 1A, 1B, 1C, and 1D are simplified diagrams of systems for delivering podcasts according to embodiments of the present invention;

FIG. 2 is a simplified diagram of a method for delivering podcasts to communication devices according to an embodiment of the present invention;

FIG. 3 is a simplified diagram of an alternative method for delivering podcasts to communication devices according to an alternative embodiment of the present invention;

FIG. 3A is a simplified diagram of yet an alternative method for delivering podcasts to communication devices according to an alternative embodiment of the present invention;

FIG. 3B is a simplified system diagram of delivering podcasts to communication devices according to an alternative embodiment of the present invention;

FIG. 4 is a simplified diagram a method for delivering podcasts and temporarily suspending the podcasts to communication devices according to an alternative embodiment of the present invention;

FIG. 5 is a simplified diagram of a system for delivering podcasts and temporarily suspending the podcasts to communication devices according to the alternative embodiments of the present invention;

FIG. 6 is a simplified diagram a method for populating a database with podcasts according to an embodiment of the present invention;

FIG. 7 is a simplified diagram of a system for populating a database with podcasts according to an embodiment of the present invention;

FIG. 8 is a simplified diagram of a method for subscribing to podcasts according to an embodiment of the present invention;

FIG. 9 is a simplified diagram of a method for adding a podcast to user's channel according to an embodiment of the present invention;

FIG. 10 is a simplified diagram of unsubscribing to a podcast according to an embodiment of the present invention;

FIG. 11 is a simplified diagram of downloading new podcast episodes according to an embodiment of the present invention;

FIG. 12 is a simplified diagram of playing a podcast according to an embodiment of the present invention;

FIG. 13 is a simplified diagram of playing a channel according to an embodiment of the present invention; and

FIG. 14 is a simplified diagram of task queuing according to an embodiment of the present invention.

### DETAILED DESCRIPTION OF THE INVENTION

According to the present invention, techniques for voice communications are provided. More particularly, the present invention provides a method and system for selectively outputting one or more podcasts using communications devices. As an example, the present invention is provided in the context of delayed broadcasting and messaging. It relates specifically to the distribution to telephone handsets, and other devices capable of receiving telephone calls, of computer files known as podcasts that are available on the Internet and that typically are downloaded and processed either by general purpose computers or by special purpose devices other than telephones. The present invention further relates to methods for using database systems to download, transcode, manage, store, and redistribute podcast files, as well as other applications.

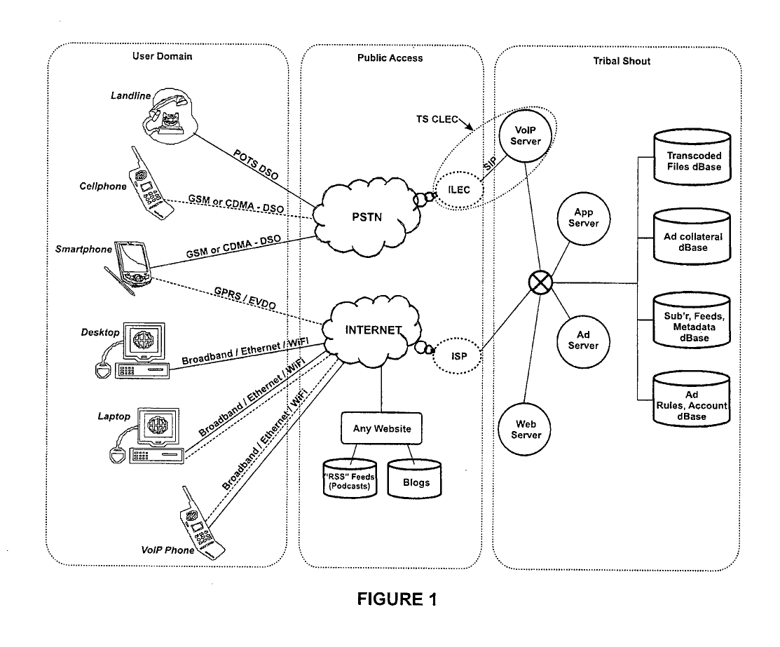

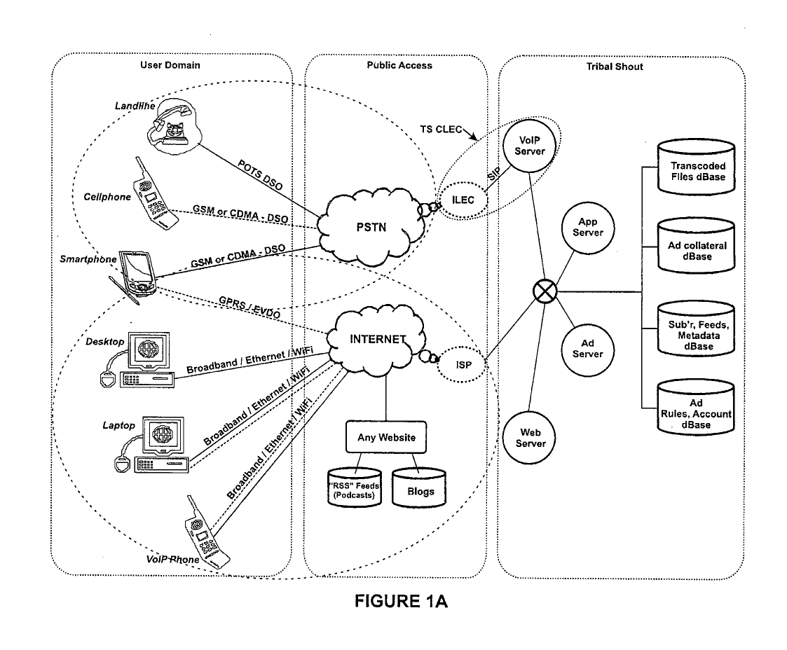

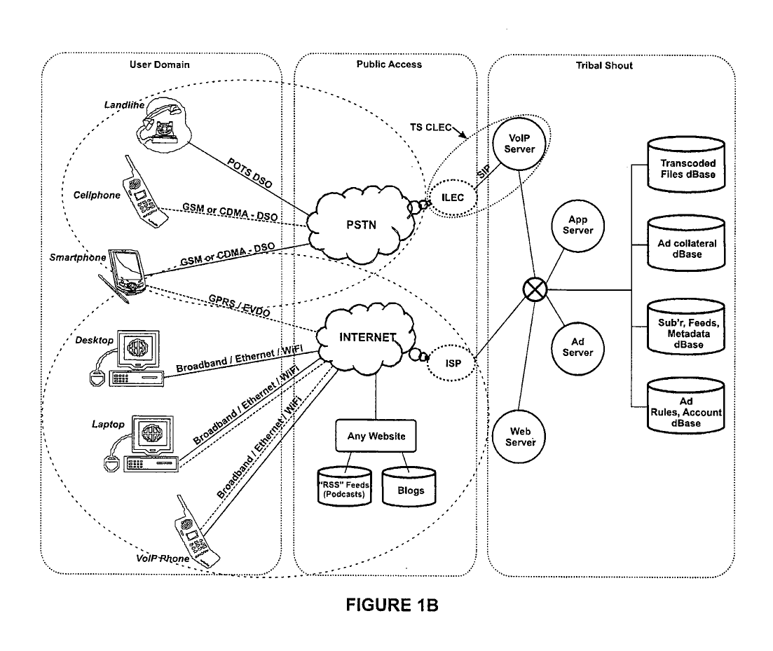

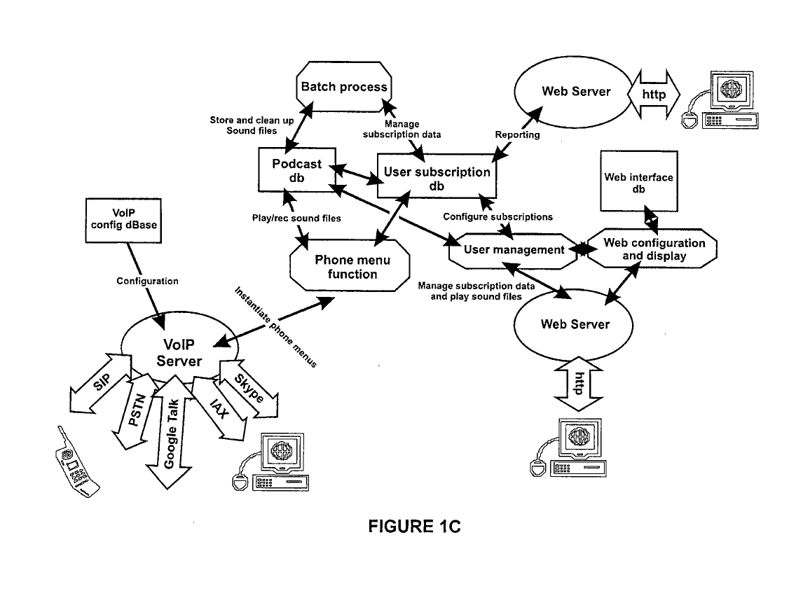

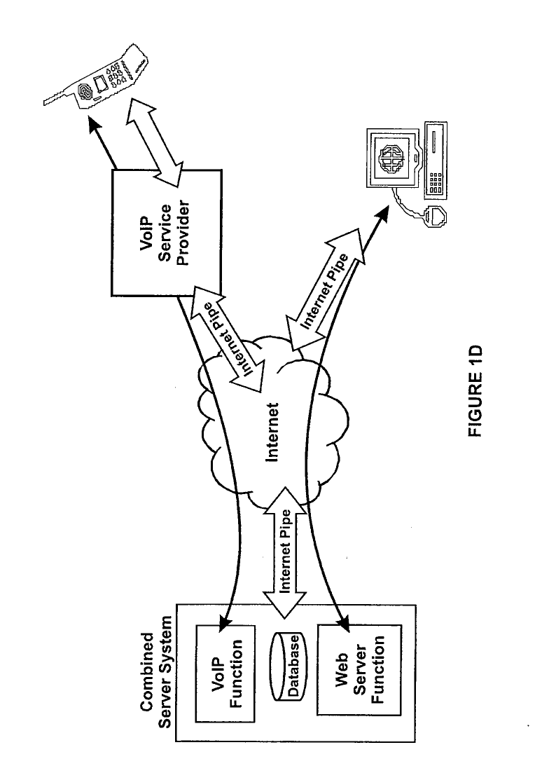

FIG. 1 is a simplified diagram of a system for delivering podcasts according to an embodiment of the present invention. This diagram is merely an example and should not unduly limit the scope of the claims herein. One of ordinary skill in the art would recognize many variations, modifications, and alternatives. FIG. 1A is a simplified block diagram 101 of the system for delivering podcasts according to an embodiment of the present invention. As shown, an overall network system includes user devices, public access system, and a system for distributing podcasts according to an embodiment of the present invention. Of course, there can be other variations, modifications, and alternatives.

In a specific embodiment, the user devices can be almost any communication device. Such communication device includes, but is not limited to, a hard landline (e.g., POTS), cellular phone, smart phone, desktop computer, laptop computer, VoIP phone, any combination of these, and the like. Each of the devices can be coupled to the public access system according to an embodiment of the present invention. As shown, the hard landline (e.g., POTS) is coupled to a Public Switched Telephone Network (PSTN). The PSTN generally refers to the international telephone system based on copper wires carrying analog voice data. Alternatively, the network can be base on digital technologies, such as ISDN and FDDI and others. Cellular phone uses GSM or CDMA, which is similar to the smart phone, which can also use GPRS/EVDO to communicate to the Internet. The other devices including desktop computer, laptop computer, VoIP phone, any combination of these, and the like can use broadband, Ethernet, and/or WiFi, commonly an IEEE 802.11 and like standards. Of course, there can be other variations, modifications, and alternatives.

Referring again to FIG. 1, the Internet couples to any Website, which uses RSS Feeds and blogs. As also shown, PSTN couples through ILEC to a VoIP server. ISP couples to a plurality of servers including an application server, an advertisement server, and a web server, among others. Each of the servers has access to one or more databases including transcoded files, advertisement collateral database, subscription information, feeds, metadata database, advertisement rules and accounting database, and possibly others. Further details of these diagrams are provided in explanations in FIGS. 1A and 1B.

Referring to FIG. 1A, system 100 includes standard telephony 101 according to a specific embodiment. As shown, the user hears through the ear piece and sends commands using DTMF key presses. In a specific embodiment, the system also implements speech recognition so the user will also use the microphone to speak into to create audio blogs and the like. Depending upon the embodiment, the standard telephone includes, among others, land line, cell phone, and/or Smart Phone, but can be others. Connection occurs using POTS, GSM or CDMA, among others. The smart phone also includes SPRS/EVDO, and the like. Each of these devices is coupled to PSTN, which is coupled to an ILEC, which is coupled using SIP to a VoIP Server, as shown. Further details are provided throughout the present specification and more particularly below.

Additionally, desk top or lap top region 121 uses standard web-browsing technologies, which can be coupled to the Internet using a broadband, Ethernet, or wireless, e.g., WiFi. In a specific embodiment, the client device includes some sort of input capability for entering text and pointing. Additionally, the client device includes a graphical display. In a specific embodiment, the system includes Voip devices 119, which use IP to move sound but provide interfaces to the user as described in the top region. Of course, there can be other variations, modifications, and alternatives.

In a specific embodiment, the CLEC 103 connects to an ILEC either a) with bundles of 24 DSO's commonly called T1 lines or b) by SIP. In either case the VoIP server provides a DTMF-based interface, but can be others. Selection choices are spoken to use user based on their account configuration. The user makes selections with DTMF keypresses. The server plays waveform files either from it's local file system in the case of very static phrases like “Please enter your pin”. In a specific embodiment, the server retrieves from the subscriber database, caches and plays custom prompts such as the name of a podcast feed. The server plays transcoded podcast episodes from a files database. Of course, there can be other variations, modifications, and alternatives.

In a specific embodiment, the VoIP Server couples to multiple servers including App Server, AD Server, and Web Server, among others. Each of these servers is coupled to a plurality of databases, including Transcoded Files Database, Ad Colateral Database, Subscribers/Feeds/Metadata database, and Ad Rules/Accounting Database, and others. Referring now to reference numeral 105, the Transcoded files database caches all the or desired podcast episodes that are associated with user subscriptions. The files are in a hierarchical filesystem that maps to subscriber database feeds, which enables direct access to files for playback on the phone interface based on a single query to the subscriber database. Depending upon the embodiment, there can be other databases, which will be described in more detail below.

In a specific embodiment, the ad collateral database 107 holds the ad waveform files for playback. They are transcoded and ready for playback through the VoIP server. The files are stored in a hierarchical filesystem that maps to metadata in the ad rules and accounts database. Of course, there can be other variations, modifications, and alternatives.

Referring now to reference numeral 109, the database 109 holds all the or desired user registrations, user selections, podcast feeds, podcast episodes, and the relationships between all of these, among other elements. A podcast feed consists of metadata describing the feed. A podcast episode consists of metadata about that episode which is stored the database. Included in that metadata is the URL where the original episode file can be found on the publishers site. That URL is utilized in two ways: 1) the URL is provided to the user's browser so that the user's browser can play the episode, 2) the URL is used by the app server to retrieve, transcode, and cache the transcoded copy in the files database above. Of course, there can be other variations, modifications, and alternatives.

Referring to FIG. 1A again, the ad database 111 holds all or desired information relating to ads including the ads themselves, the parameters for the algorithms to determine which ad to play, and the accounting of what was play. The parameters include information like advertiser, what the advertiser paid for, etc. Such information is used by the algorithms implemented in the ad server to determine what ad to play in what spot or even whether or not an ad should be played. The accounting information is both used for driving the algorithms and for accounting and auditing purposes. Of course, there can be other variations, modifications, and alternatives.

In a specific embodiment, the App Server 117 manages the relationship between the users, the podcast feeds, the episodes and the transcoded files. Also, the App Server manages loading of the system through a queuing mechanism that executes different tasks at different priorities and ensures takes are executed as soon as spare resources are available. Also, the App Server manages polling of every podcast feed to see if the publisher has made changes to the feed or published new episodes. The polling is done based on an algorithm and a variety of parameters. The App Server also processes the podcast feed to extract all or desired relevant information, store the relevant information into the database, and initiate new processes based on that information. Of course, there can be other variations, modifications, and alternatives.

Referring to reference numeral 115, the Ad Server is consulted by the VoIP server when inventory is available. The Ad Server uses the information in the Ad Database to determine what ad, if any should be played. The Ad Server is the implementation of the algorithms for Ad Display. Referring now to reference numeral 113, the web server is a conventional server of HTML, but can be other, including customized versions. The implementation of the web pages are generated dynamically based on database content. The user's information including account and subscription information, the system-wide podcast feeds, and episodes are displayed according to the current state of the database. Further details of the present system can be found throughout the present specification and more particularly in reference to FIG. 1B and associated description below.

Referring now to reference numeral 131 in FIG. 1B, a flow between the phone device and the VoIP server is a command/response system. The user dials in. The system asks for the user's phone number and pin, unless the phone number is in the CID. The user hears a combination of static prompt waveforms and waveforms customized based on configuration selections they've made on the web or phone. Those waveforms instruct the user to select from podcast feeds for listening, to manage the feeds, such as delete episodes, and to manage playback of the feeds such as pause, jump back, jump forward, play envelop, etc. As shown, the communication traverse through PSTN, ILEC, and VoIP Server, via SIP interface. Further steps are described in more detail below.

Referring now to reference numeral 137, the app server receives configuration updates through the web server according to user selections. The app server maintains the subscriber database based on user selections and XML feeds. The app server uses an algorithm to estimate when a feed may have new content and then polls the feed. The feeds are evaluated for changes. Changes in metadata result in database udpates. Changes in episode listing result in deletion from the database and the transcode database of that have been removed from their feed. New episodes are added to the db and other processes are spawned to initiate the retrieval and transcode for the phone interface. The app server maintains state information also. For example a new episode may be published and nearly immediately represented as such on the web interface. However transcoding may not be complete for the phone interface. That status information is maintained by the app server so that the phone interface represents accurate prompts for the user.

Referring now to reference numeral 133, websites of interest to the present business model, method, and system provide multiple (e.g., 3) types of information:

1) The websites provide a website that assists anyone in finding their published XML feed;

2) The XML feed contains metadata that describe the feed; and

3) The XML feed contains metadata that provide URLs for the episodes associated with the feed.

In many cases the website publisher might establish a 3rd party relationship for another site to host the episodes. The third party relationship is often trivial as the feed metadata simply contain the right URL to point to the right episodes on the right site. In some cases the XML feed might also be hosted on partner site. Such hosting is also often trivial since the publisher's website simply contains the URL for the XML feed, regardless of where it's located. XML is computer code and is not intended for viewing in a browser. Publishers do not intend users to browse to the XML page. The XML code is intended to be made available to a podcast aggregation service or application. The service uses the XML computer code to display a representation of the metadata to the user and to display and easy-to-use play mechanism so that user doesn't have to interpret and manage URLs of episodes.

Referring now to reference numeral 135, the web-enabled device communicates with the present web server and with websites that contain the wave files of episodes the user plays from the web interface. The user browses to the present website. The user can choose to login and select custom feeds. The user can select from feeds listed on the system or add their own feeds. The web server responds with pages displaying browse functions, search results, the user's configuration lists, lists of episodes, etc. When the episodes are listed, the user has the option of playing the episode. When the user selects play, a player on the user's computer retrieves the file from the publisher's website and the player plays the file through the users computer speakers. Of course, there can be other variations, modifications, and alternatives.

Depending upon the embodiment, the present invention provides a system for communicating audio content from one or more web sites to one or more communication devices. In a specific embodiment, the system can include one or more of the elements described above, but can also be outside of the present specification. The system includes an account for a user, which has a first telephone number, which is uniquely associated with the user. In a preferred embodiment, the account is directed to a customized account on a web site associated with an audio service for the user. In a specific embodiment, the system has one or more media files on one or more mass storage devices coupled to the customized account on the web site for the user. Each of the one or more media files is capable of distribution by subscription (e.g., paid or unpaid) over the Internet using one or more syndication feeds. A database schema is characterized by one or more preferences for the user of the customized account according to a specific embodiment. The database schema is coupled to the customized account for the audio service.

In a preferred embodiment, the system has one or more computer readable memories including computer code(s). Such computer codes can be configured to carry out the various methods described herein, as well as outside of the present specification. In a specific embodiment, one or more codes is directed to receiving information associated with a second telephone number from a communication device. The second telephone number is associated with the audio service of the web site according to a specific embodiment. The information is associated with the second telephone number through a circuit switched telephone network from the communication device according to a specific embodiment. The second telephone number is associated with the audio process according to a specific embodiment. There are also one or more codes directed to forming a connection between the communication device and the audio service through the circuit switched telephone network and one or more codes is directed to selecting one or more of the media files using the communication device. One or more codes is directed to processing the one or more media files to convert the one or more media files from a first format to a second format. One or more codes is directed to transmitting the one or more media files in the second format through the telephone network.

The various embodiments may be implemented as part of a computer system. The computer system may include a computer, an input device, a display unit, and an interface, for example, for accessing the Internet. The computer may include a microprocessor. The microprocessor may be connected to a communication bus. The computer may also include a memory. The memory may include Random Access Memory (RAM) and Read Only Memory (ROM). The computer system may further include a storage device, which may be a hard disk drive or a removable storage drive such as a floppy disk drive, optical disk drive, and the like. The storage device can also be other similar means for loading computer programs or other instructions into the computer system.

As used herein, the term ‘computer’ may include any processor-based or microprocessor-based system including systems using microcontrollers, digital signal processors (DSP), reduced instruction set circuits (RISC), application specific integrated circuits (ASICs), logic circuits, and any other circuit or processor capable of executing the functions described herein. The above examples are exemplary only, and are thus not intended to limit in any way the definition and/or meaning of the term ‘computer’. The computer system executes a set of instructions that are stored in one or more storage elements, in order to process input data. The storage elements may also hold data or other information as desired or needed. The storage element may be in the form of an information source or a physical memory element within the processing machine.

The set of instructions may include various commands that instruct the processing machine to perform specific operations such as the processes of the various embodiments of the invention. The set of instructions may be in the form of a software program. The software may be in various forms such as system software or application software. Further, the software may be in the form of a collection of separate programs, a program module within a larger program or a portion of a program module. The software also may include modular programming in the form of object-oriented programming. The processing of input data by the processing machine may be in response to user commands, or in response to results of previous processing, or in response to a request made by another processing machine.

As used herein, the terms ‘software’ includes any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

In a specific embodiment, the present invention provides a method for communicating audio content from one or more web sites to one or more communication devices, e.g., cellular phone, VoIP phone, land line, smart phone, desktop, laptop, which may be outlined below.

1. Maintain an account for a user, which has a first telephone number uniquely associated with the user (e.g., the account is directed to a customized account on a web site (coupled to the Internet) associated with an audio service for the user);
2. Maintain one or more media files on one or more mass storage devices coupled to the customized account on the web site for the user (Each of the one or more media files is capable of distribution by subscription (paid or unpaid) over the Internet using one or more syndication feeds.);
3. Maintain a database schema characterized by one or more preferences for the user of the customized account (In a specific embodiment, the database schema is coupled to the customized account for the audio service.)
4. Input a second telephone number into a communication device (The second telephone number is associated with the audio service of the web site.);
5. Transfer information associated with the second telephone, which is associated with the audio process, number through a circuit switched telephone network from the communication device.
6. Form a connection between the communication device and the audio service through the circuit switched telephone network;
7. Select one or more of the media files using the communication device;
8. Process the one or more media files to convert the one or more media files from a first format to a second format;
9. Transmit the one or more media files in the second format through the telephone network and outputs audio information associated with the one or more media files to the user using the communication device; and
10. Perform other steps, as desired.

The above sequence of steps provides a method according to an embodiment of the present invention. As shown, the method uses a combination of steps including a way of communicating from a website to a communication device according to an embodiment of the present invention. Other alternatives can also be provided where steps are added, one or more steps are removed, or one or more steps are provided in a different sequence without departing from the scope of the claims herein. Further details of the present method can be found throughout the present specification and more particularly below.

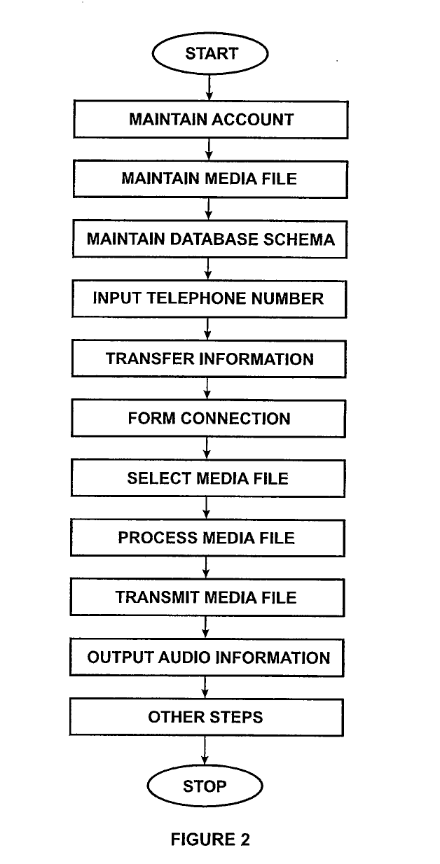

FIG. 2 is a simplified diagram of a method for delivering podcasts to communication devices according to an embodiment of the present invention. This diagram is merely an example and should not unduly limit the scope of the claims herein. One of ordinary skill in the art would recognize many variations, modifications, and alternatives.

In an alternative specific embodiment, the present invention provides an alternative method for communicating audio content from one or more web sites to one or more communication devices, which is briefly outlined below.

1. Maintain an account for a user (In a specific embodiment, the account includes a first telephone number, which is uniquely associated with the user. In a specific embodiment, the account is directed to a customized account on a web site associated with an audio service for the user. In a specific embodiment, the web site is coupled to the Internet and/or other like world wide area network.);
2. Maintain one or more media files on one or more mass storage devices coupled to the customized account on the web site for the user (In a specific embodiment, each of the one or more media files is capable of distribution by subscription (paid or unpaid) over the Internet using one or more syndication feeds.);
3. Maintain a database schema characterized by one or more preferences for the user of the customized account. (In a specific embodiment, the database schema is coupled to the customized account for the audio service.);
4. Input a second telephone number, which is associated with the audio service of the web site, into a communication device from the user of the first telephone number or a non-registered user of a non-registered telephone number;
5. Transfer information associated with the second telephone number through a circuit switched telephone network from the communication device;
6. Form a connection between the communication device of the user of the first telephone number or of the non-registered user of the non-registered telephone number and the audio service through the circuit switched telephone network;
7. Select one or more of the media files from the customized account using the communication device of the user or selecting one or more default media files for the non-registered user;
8. Process the one or more media files to convert the one or more media files from a first format to a second format;
9. Transmit the one or more media files in the second format through the telephone network;
10. Output audio information associated with the one or more media files to the user using the communication device.

The above sequence of steps provides a method according to an embodiment of the present invention. As shown, the method uses a combination of steps including a way of communicating from a website to a communication device according to an embodiment of the present invention. Other alternatives can also be provided where steps are added, one or more steps are removed, or one or more steps are provided in a different sequence without departing from the scope of the claims herein. Further details of the present method can be found throughout the present specification and more particularly below.

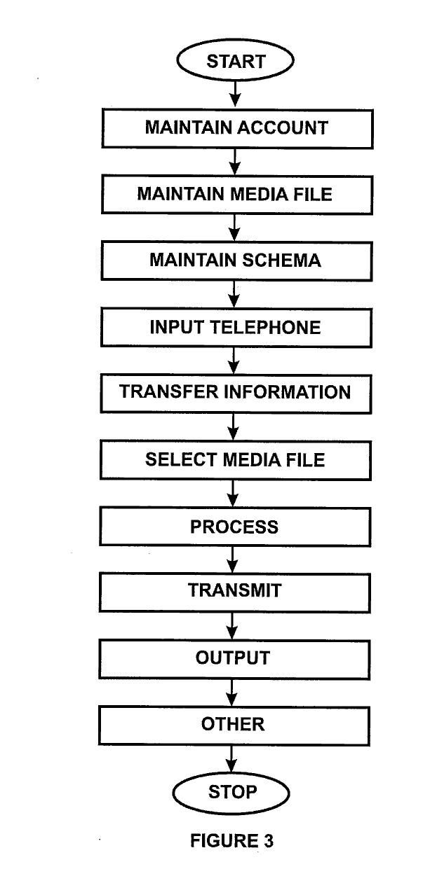

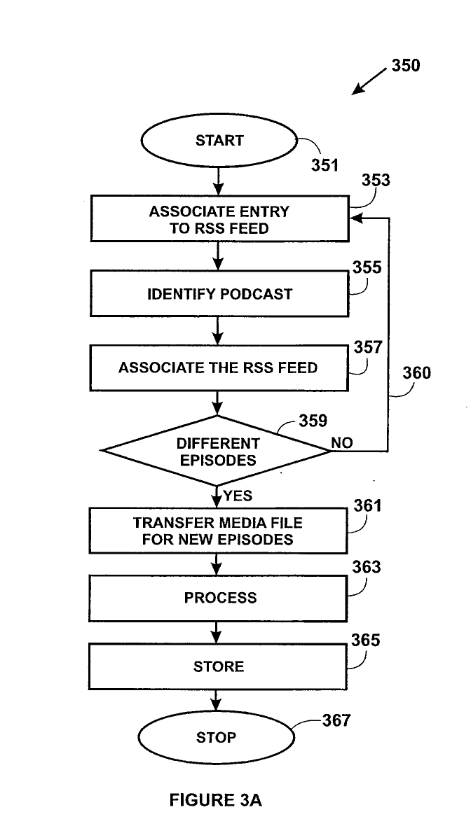

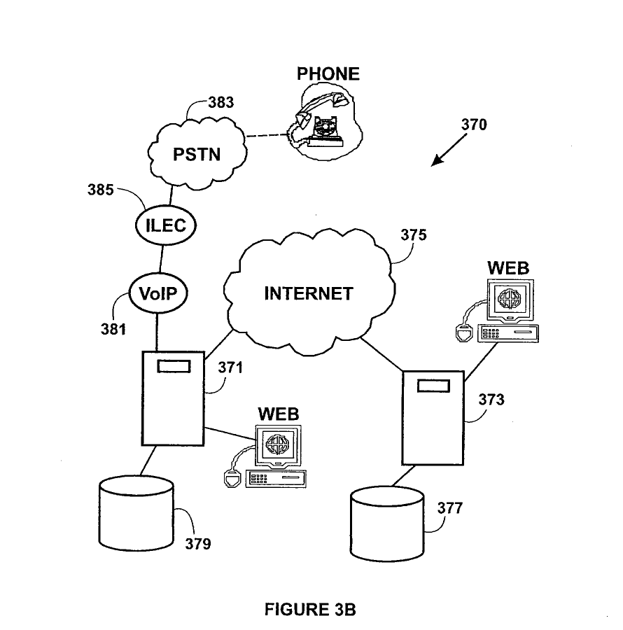

FIG. 3 is a simplified diagram of an alternative method for delivering podcasts to communication devices according to an alternative embodiment of the present invention. This diagram is merely an example and should not unduly limit the scope of the claims herein. One of ordinary skill in the art would recognize many variations, modifications, and alternatives.

In yet an alternative specific embodiment, the present invention provides an alternative method for communicating audio content, which reflects a most recent episode from a series of episodes, from one or more web sites to one or more communication devices, which is briefly outlined below.

1. Start podcast process;
2. Associate a database entry on a first server to an RSS feed from a second server at a first time, the first server being coupled to the second server through a world wide network of computers, the first server including a first website and the second server including a second website, the first time being characterized by N, whereupon N is determined time associated with a timer;
3. Identify (including display and selection process) a podcast including the RSS feed at the first server, the RSS feed including a title and one or more first episodes at the first time period;
4. Associate the RSS feed from the first server the RSS feed from the second server at a second time, the second time being characterized by N+1, whereupon N+1 is an interval time associated with the Nth time;
5. Determine whether the podcast including the RSS feed includes one or more second episodes at the second server, the one or more second episodes being different from the one or more first episodes;
6. Transfer one or more media files associated with the one or more second episodes from the second server to the first server; and
7. Process the one or more media files from a first format to a second format;
8. Store the one or more media files associated with the podcast in the second format, the second format being a transcoded format configured to be outputted through a circuit switched network, the one or more media files being associated with the podcast; and
9. Perform other steps, as desired; and

### 10. Stop.

The above sequence of steps provides a method according to an embodiment of the present invention. As shown, the method uses a combination of steps including a way of communicating from a website one or more media files, which reflect a current episode from a plurality of episodes, to a communication device according to an embodiment of the present invention. Other alternatives can also be provided where steps are added, one or more steps are removed, or one or more steps are provided in a different sequence without departing from the scope of the claims herein. Further details of the present method can be found throughout the present specification and more particularly below.

FIG. 3A is a simplified diagram 350 of yet an alternative method for delivering podcasts to communication devices according to an alternative embodiment of the present invention. This diagram is merely an example and should not unduly limit the scope of the claims herein. One of ordinary skill in the art would recognize many variations, modifications, and alternatives. A corresponding system 370 is illustrated by FIG. 3B. As shown, the method 350 begins with start, step 351. As also shown, the method is for processing a pod cast for transmission over a communication network, e.g., cellular. The method includes associating a database entry (step 353) on a first server to an RSS feed from a second server at a first time. As also shown is first server 371 and the second server 373, which can be a commercial web site having multiple podcast episodes referring to FIG. 3B. In a specific embodiment, the RSS feed is RSS 2.0 or a higher version. The associating the data base entry comprises extracting XML information from the RSS feed and populating the database entry 377 in the second server according to a specific embodiment. Preferably, the XML information comprises a feed name and a description of the RSS feed. As used herein, the first time is associated with a time such as a beginning time of the present process or other time. In a specific embodiment, the first server is coupled to the second server through a world wide network of computers, e.g., Internet 375, which is also coupled to a VoIP server 381, ILEC 385, and PSTN 383. The PSTN communicates with a phone or other communication device according to a specific embodiment. The first server includes a first website and the second server includes a second website. In a specific embodiment, first time a characterized by N, whereupon N is determined time associated with a timer, which may be coupled to either or both servers.

In a specific embodiment, the method includes identifying (step 355) a podcast including the RSS feed at the first server. The RSS feed includes a title and one or more first episodes at the first time period. The method includes associating (step 357) the RSS feed from the first server the RSS feed from the second server at a second time, which is characterized by N+1. In a specific embodiment, N+1 is an interval time associated with the Nth time. Here, the term “N” is not intended to be limited to an integer but a time, which can be referenced to GMT—Greenwich Mean Time or the like. Optionally, the method of associating the RSS feed from the first server to the second server at the second time comprises transferring an HTTP GET command from the first server to the second server. Of course, there can be other alternatives, variations, and modifications.

Referring again to FIG. 3A, the method includes determining (step 359) whether the podcast including the RSS feed includes one or more second episodes at the second server. The one or more second episodes is different from the one or more first episodes according to a specific embodiment. In a preferred embodiment, the second episode is a new or current episode from a series of episodes of the podcast. As an example, the second episode can be the latest edition of the Wall Street Journal Podcast, while the other episodes relate to earlier versions. Of course, there can be other variations, alternatives, and modifications.

In a specific embodiment, the method includes transferring (step 361) one or more media files, which are provided in mass storage device 377, associated with the one or more second episodes from the second server to the first server as illustrated by the “YES” branch. Alternatively, the method via the “NO” 360 branch returns back to step 353 or other like step. In a specific embodiment, the method includes processing 363 the one or more media files from a first format to a second format. In a specific embodiment, the second format is transcoded from a first format into G.711U, G.711a, G.723.1, G.726, G.729, GSM, iLBC, LPC10, Speex, and ISAC. Of course, there can be other versions, depending upon the embodiment.

In a specific embodiment, the method stores (step 365) the one or more media files in the second format, which is a transcoded format configured to be outputted through a circuit switched telephone network. In a specific embodiment, the storing occurs on one or more memory devices coupled to the second server. In a specific embodiment, the one or more media files are associated with the podcast. In a preferred embodiment, the podcast is one of a plurality of podcasts on the first server. Depending upon the embodiment, other processes can also follow or be added to or between any of the steps described herein or outside of the present specification. In a specific embodiment, the method includes outputting the one or more media files on a communication device coupled to the second second server. In an alternative specific embodiment, the method includes transferring the one or more media files from the second server to a communication device coupled to the second server through at least a cellular phone network. In yet an alternative embodiment, the method includes transferring the one or more media files from the second server to a communication device coupled to the second server through at least a VoIP phone network or other network. As shown, the method includes a stop step, 367.

The above sequence of steps provides a method according to an embodiment of the present invention. As shown, the method uses a combination of steps including a way of communicating from a website one or more media files, which reflect a current episode from a plurality of episodes, to a communication device according to an embodiment of the present invention. Other alternatives can also be provided where steps are added, one or more steps are removed, or one or more steps are provided in a different sequence without departing from the scope of the claims herein. Further details of the present method can be found throughout the present specification and more particularly below.

In still a further alternative embodiment, the present invention provides a method for communicating audio content from one or more web sites to one or more communication devices, which is outlined briefly below.
1. Input a telephone number into a communication device, the telephone number being associated with an audio session;
2. Transfer information associated with the telephone number, which is associated with the audio session, through a circuit switched telephone network from the communication device;
3. Form a connection between the communication device and the audio session through the circuit switched telephone network;
4. Select one or more of the media files using the communication device associated with the audio session;
5. Process the one or more media files to convert the one or more media files from a first format to a second format;
6. Transmit the one or more media files in the second format through the telephone network;
7. Output audio information associated with the one or more media files to the user using the communication device; and
8. Terminate the audio session voluntarily or involuntarily;
9. Determine a pause point associated with a time associated with a time when the audio session was terminated; and
10. Perform other steps, as desired.

The above sequence of steps provides a method according to an embodiment of the present invention. As shown, the method uses a combination of steps including a way of communicating, using a pause point, from a website to a communication device according to an embodiment of the present invention. Other alternatives can also be provided where steps are added, one or more steps are removed, or one or more steps are provided in a different sequence without departing from the scope of the claims herein. Further details of the present method can be found throughout the present specification and more particularly below.

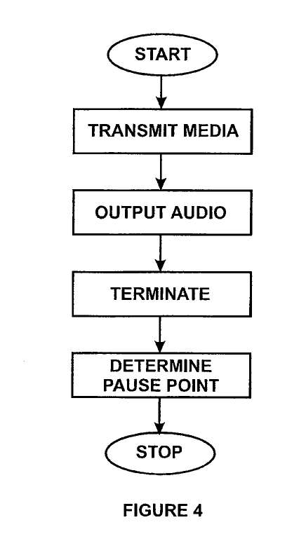

FIG. 4 is a simplified diagram a method for delivering podcasts and temporarily suspending the podcasts to communication devices according to an alternative embodiment of the present invention. This diagram is merely an example and should not unduly limit the scope of the claims herein. One of ordinary skill in the art would recognize many variations, modifications, and alternatives.

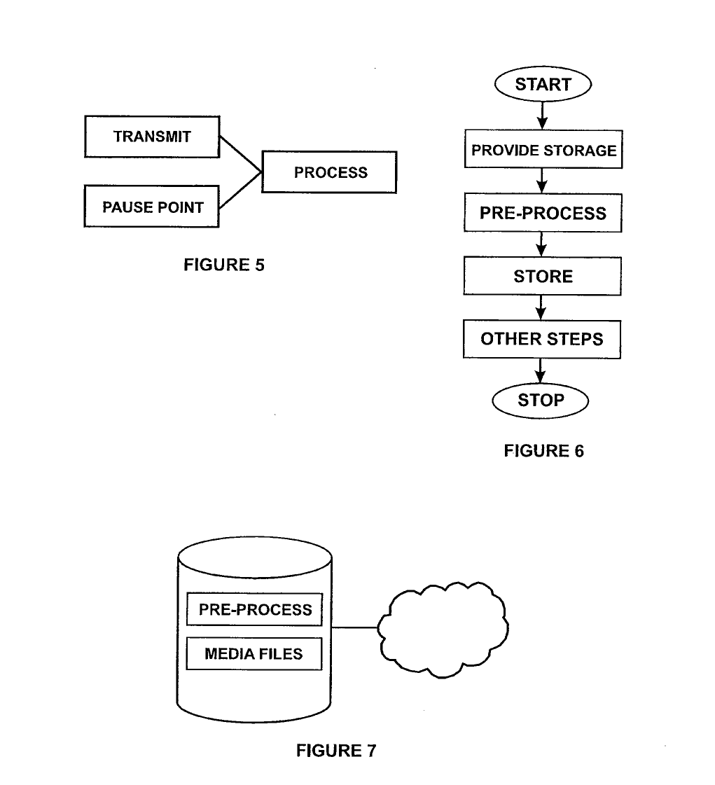

FIG. 5 is a simplified diagram of a system for delivering podcasts and temporarily suspending the podcasts to communication devices according to the alternative embodiments of the present invention. This diagram is merely an example and should not unduly limit the scope of the claims herein. One of ordinary skill in the art would recognize many variations, modifications, and alternatives.

In a specific embodiment, the present invention provides a method for populating a database, which is briefly outlined below.
1. Provide one or more mass storage devices, e.g., hard disk drives;
2. Provide one or more media files;
3. Process the one or more media files, each of the one or more media files being capable of distribution by subscription (paid or unpaid) over the Internet using one or more syndication feeds, such that each of the one or more media files being capable of being transmitted over a circuit switched and/or packet switched network coupled to the Internet;
4. Store the one or more media files onto one or more portions of the one or more mass storage devices; and
5. Perform other steps, as desired.

The above sequence of steps provides a method according to an embodiment of the present invention. As shown, the method uses a combination of steps including a way of populating a database with pre-processed media files according to an embodiment of the present invention. Other alternatives can also be provided where steps are added, one or more steps are removed, or one or more steps are provided in a different sequence without departing from the scope of the claims herein. Further details of the present method can be found throughout the present specification and more particularly below.

FIG. 6 is a simplified diagram a method for populating a database with podcasts according to an embodiment of the present invention. This diagram is merely an example and should not unduly limit the scope of the claims herein. One of ordinary skill in the art would recognize many variations, modifications, and alternatives.

FIG. 7 is a simplified diagram of a system for populating a database with podcasts according to an embodiment of the present invention. This diagram is merely an example and should not unduly limit the scope of the claims herein. One of ordinary skill in the art would recognize many variations, modifications, and alternatives. As shown is database system comprising media files to be transmitted to one or more communication devices. The database system has a web interface coupled to the Internet and one or more mass storage devices coupled to the web interface. The system also has one or more media files provided on the one or more mass storage devices coupled to the web interface. Each of the one or more media files is capable of distribution by subscription (paid or unpaid) over the Internet using one or more syndication feeds. Each of the one or more media files is pre-processed to be transmitted over a circuit switched and/or packet switched network coupled to the Internet. A plurality of database schema numbered from 1 through N, where N is an integer greater than 10, are included. Each of the numbers is associated with a unique user from a plurality of users. The plurality of users are numbered respectively from 1 through N. Each of the data schema is characterized by one or more preferences for the unique user.

It is also understood that the examples and embodiments described herein are for illustrative purposes only and that various modifications or changes in light thereof will be suggested to persons skilled in the art and are to be included within the spirit and purview of this application and scope of the appended claims.

### EXAMPLE

In a specific embodiment, the present invention provides a system and method for distributing audio podcasts via the commercial telephone system or such other telecommunication system that is capable of interconnecting to a commercial telephone system and delivering signals and message traffic to terminal devices, including over wired and wireless networks, for termination on various types of terminal devices, including standard telephone handsets. The system is comprised of special methods and algorithms implemented on high-speed servers with database management software. In a specific embodiment, the system and method transcodes podcasts from a format that is otherwise not suitable for listening on standard telephones, stores the transcoded podcasts, and retransmits them on demand for listening on standard telephones. A hierarchical file structure that maps to the stored transcoded files gives remote and mobile users fast and easy access to episodes of their choice. Specific terms are defined below, but should not depart from definitions known to one of ordinary skill in the art.

“Podcast(s)” and “audio podcast(s)” as used in this patent document mean any type of multimedia content that has audio content and is capable of being transmitted over telephone networks and received and processed by user terminal devices.

“Telephone” and “telephone handset” as used in this document mean any device that is capable of sending, receiving, and processing signal and message traffic using one or more protocols and coding that are commonly used or might come into use on commercial telephone or telecommunication systems, including wired and wireless. Telephones initiate or receive connections to a central office, send or receive signal tones, convert acoustic audio signals to telephone traffic signals and vice versa, and terminate connections.

The purpose of the method and system is to support new and valuable services (“Services”) that can be provided to users without the need for users to have additional equipment or to make changes to existing equipment according to a specific embodiment. The method and system can afford users greater flexibility and mobility at no cost to them. The method and system is scalable to handle an unlimited number of users according to a specific embodiment. Notwithstanding that the method and system allow reception of podcasts on existing telephone sets and terminal devices capable of processing telephone traffic, the present method is fully capable of accommodating future generations of terminal devices that are designed to be compatible with the worldwide telephone networks. Of course, there can be other variations, modifications, and alternatives.

The method and system operator will have the ability to distribute advertisements or other customized messages to users, which will allow the Services to be offered as commercial services, but at no cost to users according to a specific embodiment. It will also make the Service attractive to corporations or other entities that wish to distribute targeted messages to employees, customers, or other select groups. An example of such targeted usage would be pre-recorded maintenance or trouble-shooting methods that could be selected on an as-needed basis by field maintenance personnel. Another example would be distribution of urgent messages for remote personnel who would receive the messages when they dialed into the system (and identified themselves), regardless of the podcast that they selected.

Features

User Interface

An individual who wishes to learn about the Services or become a registered user will log onto the system web site and communicate interactively through a graphical user interface (“GUI”).

Users are not required to register, but registered users will have the ability to make personalized selections of podcasts that will then be transcoded and stored on the system servers for instant playback. Registered users will be given unique personal identification numbers to insure that their respective selections are made available to them in personalized menus when they log onto to the system for podcast listening.

Registered users will be able to create custom channels comprising multiple podcast feeds. This will allow a user to interleave podcast feeds to create a virtual stream of, for example, a weather feed, a news feed, and a sports feed. In this way, a user can create personalized news and entertainment channels.

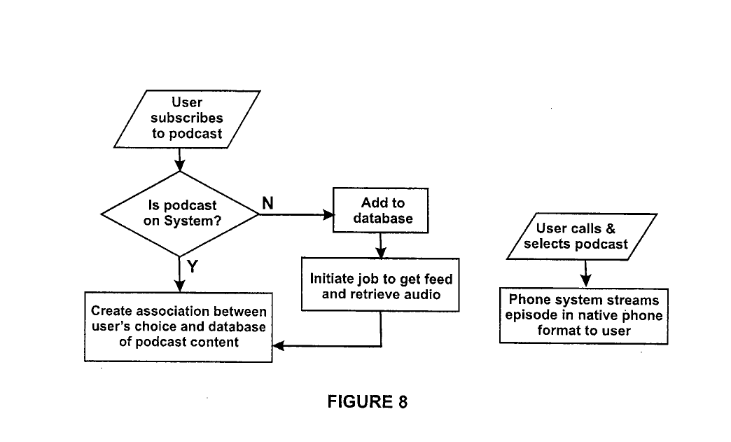

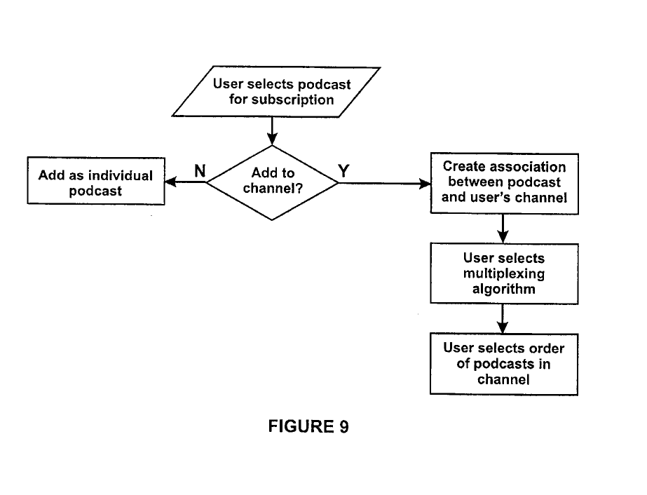

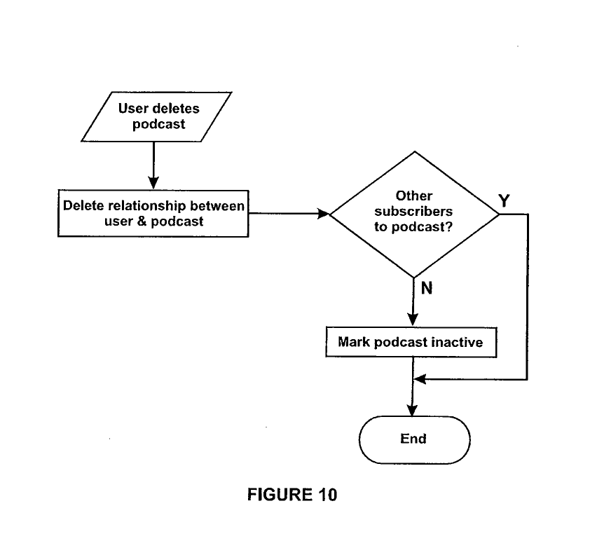

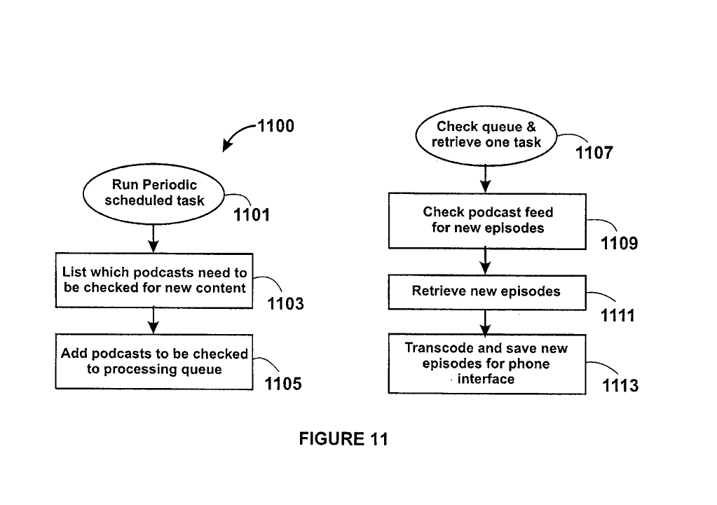

Subscribing to Podcasts (See FIGS. 8 and 9)

A registered user can “subscribe” to a podcast in order to ensure that the desired episodes are transcoded and stored on the system for future listening. The system is designed to make finding and subscribing to podcasts easy. When a podcast is “introduced” to the system by the first subscriber it is transcoded and stored on the system. As a result, each individual episode is transcoded only one time and playback to users is faster and smoother than it might be if episodes were transcoded in real time at the time of play. Transcoding in advance and only once per episode increases the efficiency of the system and requires fewer resources.

In order to subscribe to a podcast, a user must find the podcast. In the vernacular of the Internet, this means finding the URL (e.g., Uniform Resource Locator refers to the Internet address or location of a web site) of the XML (e.g., Extensible Markup Language is a text format for exchanging data over the Internet) feed associated with the podcast of interest. However, XML is a computer language that most users would only be able to read with difficulty, if at all.

Individual publishing sites frequently will identify their podcasts with icons; however, it can be difficult which link is actually the correct link to copy and paste into a podcast aggregation (podcast listening) application. For this reason, users rarely identify their own podcast feeds. Instead, users typically use commercial podcast directories to find podcasts by subject matter. Such directories lack several advantages of a generic search. First, these directories don't have strong search algorithms like those found at Google and Yahoo, so it can be difficult for a user to sort through the results of a search of a directory that contains tens or hundreds of thousands of podcasts from around the world. Second, podcast directory interfaces are custom to each directory and not all are as user-friendly as the more common search engines.

The present invention uses the API's (e.g., Application Programming Interfaces) of common search engines to make it quicker and easier for users to find podcasts of interest. It does this in several ways:

XML information is formatted and displayed in a form that is readable and understandable by individuals who are not familiar with XML.

It allows a user to select an episode for a preview.

The display contains a link to the user's personal podcast aggregation account that enables the user to easily add the podcast to his account.

The system web site has embedded links to popular search engines. When a user enters a search string that describes his desired podcast content, the system automatically adds the following string; “podcast filetype:xml.” This ensures the most efficient use of the search engine by eliminating returns that do not include links to podcasts.

When the search engine presents the results of the search, the user will have the normal choices of skipping or previewing returns.

When a user finds a podcast he wishes to sample, he will indicate that by clicking on a button on the screen and the URL of the selected site will be captured by the system.

The system will extract information from episodes at the selected site, including URL's of associated audio and video files and present that information to the user who can then sample the podcast.

If the user wishes to subscribe to the podcast, a button on the screen allows him to do so. The system will then associate the podcast with that user.

### User Channels

Using the GUI, a user can create one or more personalized channels of preselected podcasts. Podcasts can be added to one or more channels at the time the user subscribes to a podcast or at any time later. The user has control over the order of playoff podcasts in a channel through the use of system algorithms. The following are examples of multiplexing options that are available to a user for ordering the playback of selected podcasts:

Suppose a user has selected podcast feeds A, B, and C.

Further suppose that each podcast feed has episodes 1, 2, and 3 where episode 2 is more recent than episode 1 and 3 is more recent than 2.

Selecting the Reverse Interleave algorithm would play episodes in the following order: A3, B3, C3, A2, B2, C2, A1, B1, C1

Selecting the Forward Serial algorithm would play episodes in the following order:

A1, A2, A3, B1, B2, B3, C1, C2, C3

### Preprocessing Podcasts

Podcasts are preprocessed and stored on the system prior to the first request for playback. Preprocessing consists of transcoding podcasts from their native Internet formats into a format that can be delivered to users over the telephone system and played on standard telephone sets.

Preprocessing ensures the best playback experience for users and is the most efficient use of system resources because episodes are never transcoded more than once, they are never stored in multiple copies on the system, and transcoding is not done in real time at the time of playback.

Transcoded podcasts are stored on the system in read-only files so that an unlimited number of users can simultaneously play the same podcast without interference or loss of functionality.

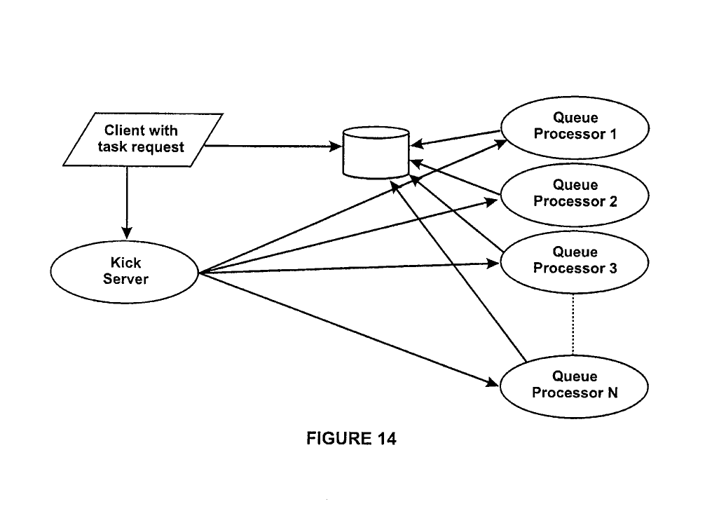

Without user action, the system periodically checks podcast feeds to see if new episodes are available or other changes have been made. New episodes are transcoded and stored on the system for playback to users who have subscribed to such podcasts. FIG. 14 illustrates this process 1100, which is merely an example.

Older episodes that are not played for some period determined by the system manager will be marked as inactive and, following some additional period of non-use, deleted from the system. As shown, the method determines that a podcast is periodically checked to see if a new episode is available according to a specific embodiment. When such new eposide is available, it is transcoded and provided on a system and available for user to a user that has subscribed to the podcast according to a specific embodiment. As shown, the method includes performing a periodic check using a scheduled task, step 1101. The method lists which podcasts require to be checked for new content, step 1103. The method adds the podcasts to be checked to a processing queen, step 105. In a specific embodiment, the queue is checked and a task is retrieved, step 1107. In a specific embodiment, the method checks a podcast feed, which is an RSS feed, for a new or current episode, step 1109. If the episode is new, the method retrieves the new episode, step 111. The method transcodes and saves (step 1113) the new episode to be used in a circuit switched or packet switched phone network according to a specific embodiment. Of course, there can be other variations, modifications, and alternatives. As an example, we have also provided a listing of pseudo code for performing a method of determining a new episode below. Of course, one of ordinary skill in the art would recognize other variations, modifications, and alternatives. Additionally, the code below is not intended to limit the scope of the claims herein.

Playback New Episode Example

```
User Adds Feed To account
// Function to add feed to database
Add_feedURL( ) {
    Argument1 =” URL of feed user wishes to subscribe to”;
    feedURL = Argument1;
    if ( feedURL in feed_database(case sensitive) ) {
        Add a pointer to user's account list for this entry;
        Exit;
    } elseif (feedURL in feed_database (case insensitive) &&
    database(previously active)
    ) {
        Add a pointer to user's account list for this entry;
        Exit;
    } else {
        Create new entry in feed_database with feedURL;
    }
    Call check_feedURL( );
}
// Function to check feed for new episodes
Check_feedURL( ) {
    If (timestamp exists) {
        If (“last timestamp” exists) {
            Delta = timestamp − “last timestamp”;
            If (Delta NOT big enough) {
                Exit;
            }
        }
        Copy timestamp to “last timestamp”;
    } else {
        Enter timestamp of current time to feed_database for feedURL;
    }
    Get feedURL via internet;
    Process “channel” parameters and store into feed_database for
    feedURL;
    Read list of episodes from feed;
    Read list of episodes from database;
    For each episode in feed AND each episode in database {
        If (episode in database BUT not in feed) {
            Mark episode deleted in database;
        } elseif (episode in database AND in feed) {
            Skip;
        } else {
            Add episode from feed to database;
            process “item” parameters for episode and add to database;
            Mark episode new;
        }
    }
    For each episode in database marked new {
        Get URL from database for “enclosure” item;
        Get file from remote server via URL;
        If (file format is supported) {
            Transcode file to G.711u;
            Save file;
        }
    }
}
```

Again, the example above is merely intended to be illustrative.

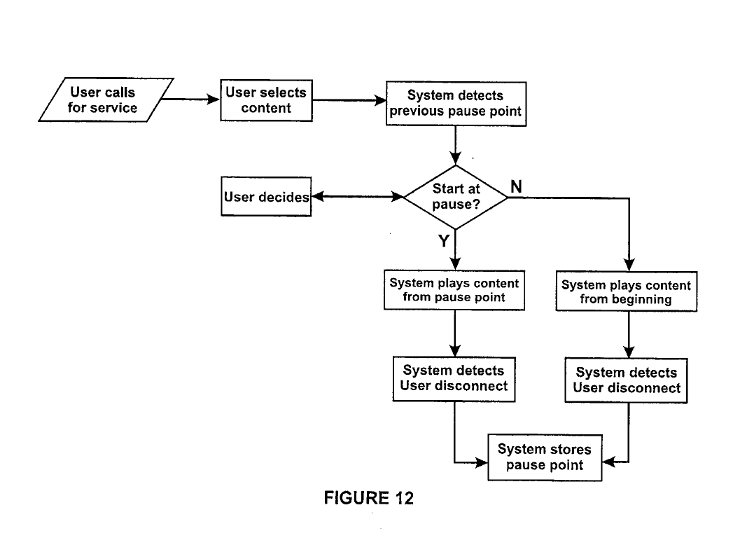

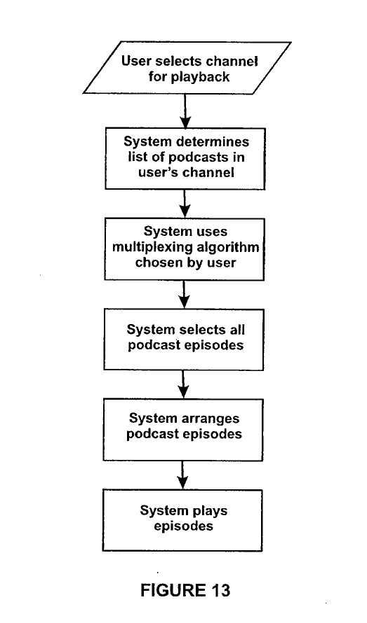

### Playing A Podcast or Channel (See FIGS. 12 and 13)

To listen to podcasts, a user will call into the system and communicate with the system through a telephone user interface (“TUI”). The caller will hear prompts from the system and will respond either by speaking or via the handset keypad (DTMF (e.g., Dual Tone Multi-Frequency, meaning the touch-pad tones defined by ATT/Bell Labs for selecting digits or values on a telephone system)) or through some combination thereof. The system is indifferent to whether a user calls over the public telephone network or over an IP (e.g., Internet Protocol—The Internet itself is sometimes referred to as the “web” or the “world-wide web”) network (via SIP (e.g., SIP (Session Initiation Protocol) refers to a signaling protocol used to create session-oriented connections between two or more devices on an IP network)).

Non-registered users will be able to choose podcasts from a menu of selections made by the system manager. Registered users will be able to choose from the standard selections and, as well, from their personalized selections.

When listening to podcasts, users will have features such as the ability to jump backward or forward, and pause or stop and restart at the pausing or stopping point. Such features are not normally associated with podcast playback.

If a user disconnects (i.e., hangs up) or is inadvertently dropped by the telephone system, the system's podcast playback subroutine creates a marker of the point in the episode file at which the disconnection occurred. This marker is saved in the database that is associated with the user and is tied to the relevant episode file. If the user subsequently reconnects to the system and chooses to play the episode again, the system identifies the marker as a non-zero saved pause point and offers the user the option to resume at the point of disconnection. In practice, the system restarts such an episode at a point a few seconds prior to the actual point of termination to enable the user to recognize that it is in fact the point where the disconnection occurred. Restarting a podcast at a pause point can be done whether a user was listening to an individual podcast or to a customized stream (channel) of podcasts.

Because podcasts are transcoded and stored on the system in read-only format, multiple users can play the same podcast simultaneously with mutually independent start, pause, and end times.

### Institutional Applications

Corporations, government agencies, and other institutions will have the ability to identify their clients and make podcasts available to them for private messaging. Registered users who are identified as institutional clients will be able to listen to their respective sets of institutional podcasts as well as to the other selections that normally are available to them as registered users.

### System Architecture

### General

The attached drawing shows the functional architecture of the system and its interfaces to the outside world. In implementation, some of the servers that are shown might be implemented as virtual servers or, in the case of a very large user base, subdivided into multiple servers. Similarly, database functionality might be redistributed according to the demands of scale.

### Servers

Application servers perform system back-office functions and manage the relationships among users, podcast feeds, transcoded podcast episodes, advertisements, task priorities, and queuing.

VoIP (e.g., Voice over IP—means voice telephony over a network using the Internet Protocol; i.e., voice telephony over the Internet) Server—This server provides a DTMF interface to the CLEC (e.g., CLEC—competitive local exchange carrier) or ILEC (e.g., ILEC—incumbent local exchange carrier), such as the case might be. The server communicates interactively with users. It provides prompts to users by playing waveform files either from its own file system (in the case of the most frequent prompts) or from the User Feeds, Metadata database and retrieves and acts upon user inputs. This server also retrieves and plays transcoded podcast episodes from the Transcoded Files database.

App Server—This server performs the following functions:

It manages relationships among users, podcast feeds, episodes, and transcoded files.

It controls system loading by assigning resources according to a pre-established set of rules and priorities.

It directs polling of podcast feeds to extract podcast information and to detect updates or other changes.

Ad Server—This server manages the placement of ads (or other targeted messages) based on available inventory (as determined by the VoIP server). It retrieves ads and other messages from the Ad Collateral Database and places them in accordance with instructions contained in the Ad Rules, Accounts Database.

Web Server—This is an HTML server that controls the system web pages. It generates web pages dynamically based on information stored in the User Feeds, Metadata and Ad Rules, Account databases.

The Web Server supports a graphical user interface (GUI) that contains the same user-selected content as the telephone user interface (TUI). The system uses the same database for the information and presents it in web format. This allows a user to manage his individual choices on one interface and have those choices reflected on the other interface. For example, podcast episodes that are deleted on the GUI will be deleted on the TUI.

The user has the option to play episodes in-line from the web page using technologies such as the Macromedia Flash (e.g., Macromedia Flash—A computer client application owned by Adobe Systems) MP3 player engine or Apple's Quicktime (e.g., Quicktime—A computer client application owned by Apple Computer).

Database Server—This Server processes episode files for storage and distribution to users and hosts user databases.

Kick Server—The Kick Server (aka Message Master) manages the Queue Processors to ensure that tasks in the queue are prioritized and performed as soon as resources are available. It sends stateless messages to Queue Processors to cause them to search for tasks in queue. Depending on system load, the Kick Server can be a single server or an array of servers acting through a load balancer. FIG. 14 shows the relationship between Kick Server and Queue Processors.

Queue Processor)—A Queue Processor that is performing a task will disregard new task requests until the current task is complete and marked as such. Queue Processors have preassigned priorities for accepting tasks which means that the available Queue Processor with the highest priority accepts the next task in the queue. This allows the system manager to monitor system loading by checking the percent availability of the Queue Processors. If the lowest priority Queue Processor has a low availability during periods of peak usage, the system is operating near capacity.

### Databases

Transcoded Files Database—This database contains transcoded episode files that are ready for listening for users thereby increasing responsiveness on the TUI.

Transcoding, as used in this patent document, means, depending on the context; (a) a process of decoding podcasts from their original Internet protocols and encoding them for transmission to telephones, or (b) decoding telephone traffic and encoding it for transmission over the Internet. Transcoded files are episode files that have been transcoded and stored on the system Servers. Transcoding is necessary because telephone systems use encoding schemes for audio traffic that are not compatible with the encoding schemes used for the same type of traffic on the Internet. For example, the U.S. public telephone system does not use MP3 (e.g., MP3—a pulse code modulation scheme for compressing audio signals), MPEG-4 (e.g., MPEG-4—an industry standard for encoding audio/video content for storing and for streaming over the Internet), or any of the other most common standards typically used for encoding audio traffic for distribution over the Internet.

The hierarchical structure of the database file system enables direct access based on a single query to the User Feeds, Metadata database.

Ad Collateral Database—This database contains transcoded ad (and other targeted message) waveform files ready for delivery to users. The files are stored in a hierarchical file system that maps to metadata in the Ad Rules, Accounts database.

User Feeds, Metadata Database—This database holds all the user registrations, user selections, podcast feeds, and the relationships among all of these. A podcast feed contains metadata describing the feed; an episode contains metadata about the episode which is stored in the database. Included in the metadata is the URL where the original episode file was found. The URL is used by the App Server to retrieve, transcode, and store the episode.

One table of this database stores a list of podcast feeds and another table stores a list of episodes associated with the feeds. When a user selects a podcast feed, a separate table stores a record of the relationship between the user and the feed. If two or more users select the same feed, the relationship table records the various user-feed relationships, but the feeds and episode tables are not affected. This ensures that the system does not process and store an episode more than one time.

A podcast feed is marked “active” as long as at least one user is subscribed to the feed and “inactive” when no users are subscribed. An inactive feed does not require system resources to keep it current.

Ad Rules, Accounts Database—This database contains ads (including targeted messages), rules for distributing the ads, accounting information, and other information related to the ads.

### Platforms

Hardware platforms (servers, primarily) and database management software are standard, commercially available items. Custom software modules implement the methods and algorithms that comprise the present invention.

In one embodiment of the invention, podcast files in MP3 format are transcoded into μlaw (e.g., μlaw (pronounced “mu-law”)—a companding algorithm used in digital telecommunications systems in the U.S.A.) format so that they can be played from within the Asterisk Voicemail system (a commercial voicemail system).

### Internal Operations

The system's servers perform back office functions including managing relationships among users, podcast feeds, episodes, advertisement and targeted message files, and transcoded episode files. Tasks controlled by the servers include podcast polling, downloading of podcast information, transcoding, and storing of episode files. The servers queue and execute tasks according to available resources and a set of pre-established priorities and algorithms.

The Ad Collateral database holds transcoded ad and other message waveform files for playback through the VoIP Server. The files are stored in a hierarchical file system that maps to metadata in the Ad Rules, Accounts database.

The Ad Server is consulted by the VoIP Server when inventory is available. The Ad Server uses the information in the Ad Collateral database to determine which ad, if any should be played.

The Ad Collateral database holds all information relating to ads, including the ads themselves, the parameters for the algorithms to determine which ad to play, and the accounting of what was played. The parameters include things like advertiser, what the advertiser paid for, etc. This information is used by the algorithms implemented in the ad server to determine what ad to play in what spot or even whether or not an ad should be played. The accounting information is both used for driving the algorithms and for accounting and auditing purposes.

The App Server maintains configuration updates based on information that it receives from the Web Server which, in turn, receives updates directly from users. The App Server uses proprietary algorithms to estimate when a podcast feed is likely to have new content and then polls the feed. Changes in podcast metadata result in updates to the system databases, such as addition or deletion of episodes. The App Server also maintains state information also. For example a new episode may be published and nearly immediately represented such as the status of transcoding.

### External Communications to Users

The system communicates with the outside world through a CLEC which connects to an ILEC via T1 (e.g., T1 refers to a digital telecommunications service that consists of 24 channels of 64 Kbps multiplexed into a single 1.544 Mbps channel) and SIP—in other words, through the commercial telephone network and the Internet.

Users connect to the system in either of two distinct ways for different purposes; either through a GUI over the Internet or through a TUI.

An Internet connection to the system's Web Server allows a user to register and set up or make changes to his account, browse the system web site for information, and listen to podcasts that are stored in transcoded files on the system servers. A user will see web pages displaying browse functions, search results, the user's configuration lists, lists of episodes, and other such information. When podcast episodes are listed, the user has the option of playing episodes.

When a user establishes a TUI connection with the system, the user is offered a menu of choices that depends upon whether or not he is a registered user. Non-registered users are offered a selection of choices that have been made by the system manager. Registered users are presented the standard choices as well as their own personalized choices based on selections they have made via the system's GUI.

Communication from user to system is, at user's option, a series of keypad entries or voice commands or a combination of the two. Communication from system to user is in the form of spoken prompts comprised of pre-recorded (waveform or other such format) files. Prompts include instructions for making choices, categories of podcasts, specific podcast names, episode titles, play instructions, and such other information as is useful for users to enjoy the service. When a user has made his selections, the system retrieves and plays the applicable, previously transcoded podcast episode(s) from a system database.

### External Communications to Podcast Feeds

The system seeks out and downloads information, including episodes, from podcasts that are either identified by registered users or by the system manager. Information about podcasts and episodes is maintained in a system database to provide the basis for prompts to users to assist them in selecting the episodes they wish to play.

The system periodically polls podcast sites from which episodes have been downloaded to determine the availability of new episodes or other changes that would be of interest to users. Podcast metadata is contained in XML on the feed web site. This information is provided for the benefit of service providers and is not generally available for viewing with a web browser. The system uses the metadata do create an easy-to-use interface for users to play episodes.

### Scalability

Processing (e.g., transcoding) audio content is CPU (e.g., Central Processing Unit—meaning the computer that comprises the server) intensive and can take several minutes per episode, depending on the length of the episode, speed of the CPU, available computer memory and other server resources, and other operations ongoing on the server. As system usage increases, either due to the number of users, the frequency and duration of user activity, or the length of podcasts processed, the system must grow to keep up with demand. Otherwise, the system will become overloaded and the user experience will deteriorate.

The present invention uses a task queuing process implemented on the Database Server. It manages system resources to ensure that real-time tasks are completed when required and with efficient utilization of resources. When the system requires processing of audio content (e.g. transcoding an episode or processing an audio prompt), the queuing process adds a task to the queue and uses an HTTP (e.g., Hyper-Text Transfer Protocol is a method of transferring information over the Internet) load balancer to assign processes to system servers.

The queuing process maintains real-time status of the servers and other resources of the system and, as appropriate, will manage those resources as master or slave resources (e.g., servers) to complete tasks that are in the queue. Each slave will establish and maintain a networked database connection to the Database Server for the purpose of receiving and managing its assigned tasks. The queuing process ensures that no two slave servers get the same task and that new tasks are assigned, as necessary, when servers become available.

The modular architecture of the system allows additional resources to be added without disruption of service or visibility by users. The need for additional capacity can be ascertained through analysis of the capacity utilization of the last slave server on the master server's process list. That last slave should always have the lowest level of loading.

The modular architecture of the system also increases reliability because a failed or overloaded server will simply be replaced by another server. History files maintained by the system facilitate debugging, performance analysis, and other important housekeeping functions.

### User Features

A system that can remember where a user left off listening to audio content on the phone interface. If the user hangs up or drops a call, the system allows the user to resume at the last point upon logging back into the system. Description: when a user hangs up a call or if a call drops, the playback subroutine passes a marker of the current point in the audio file. This marker is saved in the database associated with the user and the particular audio file. At a later time when the user chooses to play the episode again, the system identifies a non-zero saved pause point and the user is offered the option of resuming or restarting at the beginning. If resume is selected, the marker is used to enable the system to restart at the pause point. Typically usability is enhanced if the restart point is a few seconds before the actual pause point enabling the user to recognize that this is in fact the point where the left off.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method for communicating audio content from one or more web sites to one or more communication devices, the method comprising:
maintaining an account for a user, the account including a first telephone number, the first telephone number uniquely associated with the user, the account being directed to a customized account on a web site associated with an audio service for the user, the web site being coupled to the Internet;
maintaining one or more media files on one or more mass storage devices coupled to the customized account on the web site for the user, each of the one or more media files being capable of distribution by subscription (paid or unpaid) over the Internet using one or more syndication feeds;
maintaining a database schema characterized by one or more preferences for the user of the customized account, the database schema being coupled to the customized account for the audio service;
inputting a second telephone number into a communication device, the second telephone number being associated with the audio service of the web site;
transferring information associated with the second telephone number through a circuit switched telephone network from the communication device, the second telephone number being associated with the audio process;
forming a connection between the communication device and the audio service through the circuit switched telephone network;
selecting one or more of the media files using the communication device;
processing the one or more media files to convert the one or more media files from a first format to a second format;
transmitting the one or more media files in the second format through the telephone network; and
outputting audio information associated with the one or more media files to the user using the communication device.

2. The method of claim 1 wherein the one or more media files is pre-processed before maintaining the one or more media files on the mass storage device, the pre-processed one or more media files being PCM compatible (i.e., G.711u, G.711a).

3. The method of claim 1 wherein the one or more media files is associated with one or more pod casts.

4. The method of claim 1 wherein the telephone network comprises a PSTN.

5. The method of claim 1 further comprising inputting the first telephone number for the customized account using a graphical user interface coupled to the web site.

6. The method of claim 1 further comprising inputting a username for the customized account using a graphical user interface coupled to the web site.

7. The method of claim 1 further comprising selecting one or more podcast feeds associated with the one or more media files by the user through the web site to form the one or more preferences for the user.

8. The method of claim 1 wherein the communication device is selected from a PSTN compatible device, browser compatible device, or VoIP device.

9. The method of claim 1 wherein the first format is converted to the second format using a transcoding process, the first format being an Internet format, the second format being capable of transmission over the circuit switched telephone network.

10. The method of claim 1 wherein the one or more media files is pre-processed to allow for transmission over the telephone network free from one or more transcoding processes.

11. The method of claim 1 further comprising pausing the output of the audio information using one or more commands from the communication device.

12. The method of claim 1 further comprising stopping the output of the audio information using one or more commands from the communication device.

13. The method of claim 1 further comprising restarting the output of the audio information back to an initial temporal state using one or more commands from the communication device, the output of audio information being restarted including a portion previously outputted.

14. The method of claim 1 further comprising skipping forward to a second portion of the audio information using one or more commands from the communication device.

15. The method of claim 1 further comprising replaying a portion of the audio information using one or more commands from the communication device.

16. The method of claim 1 wherein the communication device comprises one or more keys.

17. The method of claim 1 further comprising disconnecting the communication device from the audio process.

18. The method of claim 1 wherein the customized user account is updated using the web site or the communication device and wherein the one or more media files is updated from time to time from respective one or more media files from one or more other web sites.

19. A system for communicating audio content from one or more web sites to one or more communication devices, the system comprising:
an account for a user, the account including a first telephone number, the first telephone number uniquely associated with the user, the account being directed to a customized account on a web site associated with an audio service for the user, the web site being coupled to the Internet;
one or more media files on one or more mass storage devices coupled to the customized account on the web site for the user, each of the one or more media files being capable of distribution by subscription (paid or unpaid) over the Internet using one or more syndication feeds;
a database schema characterized by one or more preferences for the user of the customized account, the database schema being coupled to the customized account for the audio service;
wherein the system comprises one or more computer readable memories, the one or more computer readable memories including:
one or more codes directed to receiving information associated with a second telephone number from a communication device, the second telephone number being associated with the audio service of the web site, the information being associated with the second telephone number through a circuit switched telephone network from the communication device, the second telephone number being associated with the audio process;
one or more codes directed to forming a connection between the communication device and the audio service through the circuit switched telephone network;
one or more codes directed to selecting one or more of the media files using the communication device;
one or more codes directed to processing the one or more media files to convert the one or more media files from a first format to a second format; and
one or more codes directed to transmitting the one or more media files in the second format through the telephone network.

20. A method for communicating audio content from one or more web sites to one or more communication devices, the method comprising:
maintaining an account for a user, the account including a first telephone number, the first telephone number uniquely associated with the user, the account being directed to a customized account on a web site associated with an audio service for the user, the web site being coupled to the Internet;
maintaining one or more media files on one or more mass storage devices coupled to the customized account for the user having the first telephone number on the web site for the user, each of the one or more media files being capable of distribution by subscription (paid or unpaid) over the Internet using one or more syndication feeds;
maintaining a database schema characterized by one or more preferences for the user of the customized account, the database schema being coupled to the customized account for the audio service;
inputting a second telephone number into a communication device from the user of the first telephone number or a non-registered user of a non-registered telephone number, the second telephone number being associated with the audio service of the web site;
transferring information associated with the second telephone number through a circuit switched telephone network from the communication device, the second telephone number being associated with the audio process;
forming a connection between the communication device of the user of the first telephone number or of the non-registered user of the non-registered telephone number and the audio service through the circuit switched telephone network;
selecting one or more of the media files from the customized account using the communication device of the user or selecting one or more default media files for the non-registered user;
processing the one or more media files to convert the one or more media files from a first format to a second format;
transmitting the one or more media files in the second format through the telephone network; and
outputting audio information associated with the one or more media files to the user using the communication device.

21. A method for communicating audio content from one or more web sites to one or more communication devices, the method comprising:
inputting a telephone number into a communication device, the telephone number being associated with an audio session;
transferring information associated with the telephone number through a circuit switched telephone network from the communication device, the telephone number being associated with the audio session;
forming a connection between the communication device and the audio session through the circuit switched telephone network;
selecting one or more of the media files using the communication device associated with the audio session;
processing the one or more media files to convert the one or more media files from a first format to a second format;
transmitting the one or more media files in the second format through the telephone network;
outputting audio information associated with the one or more media files to the user using the communication device;
terminating the audio session voluntarily or involuntarily; and
determining a pause point associated with a time associated with a time when the audio session was terminated.

22. The method of claim 21 further comprising forming a second connection between the communication device and the audio session and transmitting the one or more media files in the second format within a vicinity of the pause point to resume logical transmission of the one or more media files.

23. A database system comprising media files to be transmitted to one or more communication devices, the method comprising:
a web interface coupled to the Internet;
one or more mass storage devices coupled to the web interface;
one or more media files provided on the one or more mass storage devices coupled to the web interface, each of the one or more media files being capable of distribution by subscription (paid or unpaid) over the Internet using one or more syndication feeds, each of the one or more media files being pre-processed to be transmitted over a circuit switched and/or packet switched network coupled to the Internet; and
a plurality of database schema numbered from 1 through N, where N is an integer greater than 10, each of the numbers being associated with a unique user from a plurality of users, the plurality of users being numbered respectively from 1 through N, each of the data schema being characterized by one or more preferences for the unique user.

24. The system of claim 23 further comprising an updating process, the updating process being coupled to web interface, the updating process being adapted to poll one or more web sites associated with the one or more media files to determine one or more current versions of the one or more media files.

25. The system of claim 24 wherein the updating process is further adapted to maintain the one or more current versions of the one or more media files on the one or more mass storage devices.

26. The method of claim 23 further comprising a timing process, the timing process being adapted to select at least one time for a poll interval for the one or more web sites associated with the one or more media files.

27. The system of claim 24 wherein the updating process is further adapted to maintain the one or more current versions of the one or more media files on the one or more mass storage devices.

28. A method for populating a database, the method comprising:
providing one or more mass storage devices;
providing one or more media files;
processing the one or more media files, each of the one or more media files being capable of distribution by subscription (paid or unpaid) over the Internet using one or more syndication feeds, such that each of the one or more media files being capable of being transmitted over a circuit switched and/or packet switched network coupled to the Internet; and
storing the one or more media files onto one or more portions of the one or more mass storage devices.
